(19) United States
(12) Patent Application Publication
(10) Pub. No.: US 2026/0364464 A1
(43) Pub. Date: Nov. 19, 2026

(54) INFORMATION PROCESSING SYSTEM, INFORMATION PROCESSING METHOD, AND PROGRAM

(71) Applicant: GREE Holdings, Inc., Tokyo (JP)

(72) Inventor: Daichi WAKABAYASHI, Kanagawa (JP)

(73) Assignee: GREE Holdings, Inc., Tokyo (JP)

(21) Appl. No.: 19/720,898

(22) Filed: Jun. 26, 2026

Related U.S. Application Data
(63) Continuation of application No. PCT/JP2024/044894, filed on Dec. 19, 2024.

(30) Foreign Application Priority Data
Jun. 26, 2024 (JP) 2024-102750

(51) Int. Cl. A63F 13/65; A63F 13/45

(52) U.S. Cl. CPC A63F 13/65; A63F 13/45

(57) ABSTRACT

An information processing system includes processing circuitry. The processing circuitry is configured to acquire, from a storage device that stores environment information regarding environments of a virtual space in which a user plays a game, the environment information corresponding to a position selected by the user in the virtual space; automatically generate, using the environment information, game content for the game; advance the game based on operations by the user; and award a reward corresponding to the environment information to the user when a play result of the game by the user satisfies a reward awarding condition.

### CROSS-REFERENCE TO RELATED APPLICATIONS

This application claims priority to and the benefit of International Application No. PCT/JP 2024/044894, filed Dec. 19, 2024, which claims priority to Japanese Patent Application No. 2024-102750, filed Jun. 26, 2024, the entire contents of which are incorporated herein by reference.

### TECHNICAL FIELD

The present disclosure relates to an information processing system, an information processing method, and a program.

### BACKGROUND

Conventionally, there are systems that automatically generate a structure of a game field. For example, such systems automatically generate a “dungeon” (maze-like structure), which is one type of game field. The dungeon may be formed by continuously arranging a plurality of square-shaped rooms.

### SUMMARY

The present disclosure provides an information processing system, an information processing method, and a program that automatically generate game content using environment information regarding a virtual space in which a user plays a game.

One aspect of the disclosure provides an information processing system including processing circuitry configured to acquire, from a storage device that stores environment information regarding environments of a virtual space in which a user plays a game, the environment information corresponding to a position selected by the user in the virtual space; automatically generate, using the environment information, game content for the game; advance the game based on operations by the user; and award a reward, corresponding to the environment information, to the user when a play result of the game by the user satisfies a reward awarding condition.

Another aspect of the disclosure provides a method. The method includes acquiring, from a storage device that stores environment information regarding environments of a virtual space in which a user plays a game, the environment information corresponding to a position selected by the user in the virtual space; automatically generating, using the environment information, game content for the game; advancing the game based on operations by the user; and awarding a reward corresponding to the environment information to the user when a play result of the game by the user satisfies a reward awarding condition.

A yet another aspect provides a non-transitory computer-readable medium storing computer executable instructions which, when executed by processing circuitry, cause the processing circuitry to perform a process including: acquiring, from a storage device that stores environment information regarding environments of a virtual space in which a user plays a game, the environment information corresponding to a position selected by the user in the virtual space; automatically generating, using the environment information, game content for the game; advancing the game based on operations by the user; and awarding a reward corresponding to the environment information to the user when a play result of the game by the user satisfies a reward awarding condition.

### BRIEF DESCRIPTION OF THE DRAWINGS

FIG. 1 illustrates an information processing system according to a first exemplary embodiment.

FIG. 2 illustrates an example of environment information according to the first exemplary embodiment.

FIG. 3 illustrates an example of user information according to the first exemplary embodiment.

FIG. 4 illustrates an example of reward information according to the first exemplary embodiment.

FIG. 5 illustrates an example of object candidate information according to the first exemplary embodiment.

FIG. 6 illustrates a hardware configuration of an information processing device according to the first exemplary embodiment.

FIG. 7 illustrates steps of an information processing method in the first exemplary embodiment.

FIG. 8 illustrates a diagram for explaining generation of game content for each area in the first exemplary embodiment.

FIG. 9 illustrates an automatically generated movable path in the first exemplary embodiment.

FIG. 10 illustrates a diagram of a start screen in the first exemplary embodiment.

FIG. 11 illustrates a flowchart illustrating a series of steps performed in a second exemplary embodiment.

### DETAILED DESCRIPTION

### First Exemplary Embodiment

At least one computer processor (hereinafter referred to as the “processor”) included in an information processing system provides a game. The processor executes computer-readable instructions to: acquire, from a storage device that stores environment information regarding environments in a virtual space in which a user plays a game, environment information corresponding to a position selected by the user in the virtual space; automatically generate game content for the game using the environment information; advance the game based on a user operation; and award a reward corresponding to the environment information to the user when a result of a game play by the user satisfies a reward awarding condition.

[Information Processing System] An exemplary embodiment of an information processing system, an information processing method, and a program will be described below.

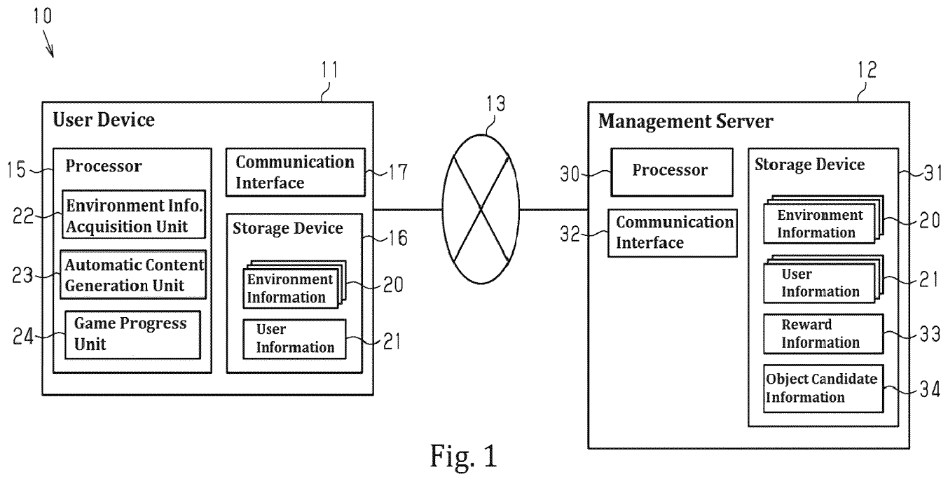

As illustrated in FIG. 1, an information processing system 10 includes a user device 11 and a management server 12. The management server 12 and the user device 11 are interconnected over a network 13. The user device 11 is a device used by a user who plays a game. The user device 11 may be a smartphone (multifunctional telephone device), a tablet device, a personal computer, a game console, a wearable computer, or any other information processing device. Examples of the wearable computer include a head-mounted display worn on a user's head, a glasses-type wearable device, and the like. The user device 11 may be a device that operates independently, or may be a set of interconnected devices that transmit and receive data among themselves. The user device 11 may also be a device on which a native application or a hybrid application for executing a game is installed (implemented), or a device that executes a game while transmitting and receiving data to and from the management server 12 using a web browser.

In the present exemplary embodiment, a case where the user device 11 stores a native application will be described. The native application includes a program for executing a game and asset data, which includes various types of data used for executing the game. The native application provides a game in which a user aims to achieve a mission (task) in a virtual space. In the exemplary embodiment, the virtual space is a space in which three-dimensional coordinates (X-coordinate, Y-coordinate, and Z-coordinate) are set. That is, an arbitrary position in the virtual space can be specified by coordinates. The virtual space includes a plurality of regions selectable by the user.

The user device 11 includes a processor 15, a storage device 16, and a communication interface 17. The storage device 16 stores environment information 20 and user information 21. The processor 15 serves as an environment information acquisition unit 22, an automatic content generation unit 23, and a game progress unit 24 by executing a program (not shown) stored in the storage device 16 or the like.

The environment information acquisition unit 22 acquires environment information 20 corresponding to a region selected by the user from among the plurality of the regions set in the virtual space, from the storage device 16 which stores the environment information 20 regarding environments of the region where the user plays the game.

The automatic content generation unit 23 automatically generates game content using the environment information 20. In the present exemplary embodiment, the game content includes at least a structure in the region where the user plays the game and an arrangement of objects in the region.

The game progress unit 24 advances the game based on user operations. Furthermore, when a play result of the game content by the user satisfies a reward awarding condition, the game progress unit 24 awards a reward corresponding to the environment information 20 to the user.

The management server 12 includes a processor 30, a storage device 31, and a communication interface 32. The storage device 31 stores the environment information 20 and the user information 21 as master information. The user device 11 may acquire the environment information 20 for a plurality of regions from the management server 12 collectively, or may acquire the environment information 20 corresponding to a selected region(s) from the management server 12 each time the user selects the region(s).

The storage device 31 also stores reward information 33 and object candidate information 34. The reward information 33 includes information regarding candidates for rewards that can be awarded to the user. The object candidate information 34 includes information regarding candidates for an object(s) that can be set as a gimmick(s) in a region when automatically generating the game content.

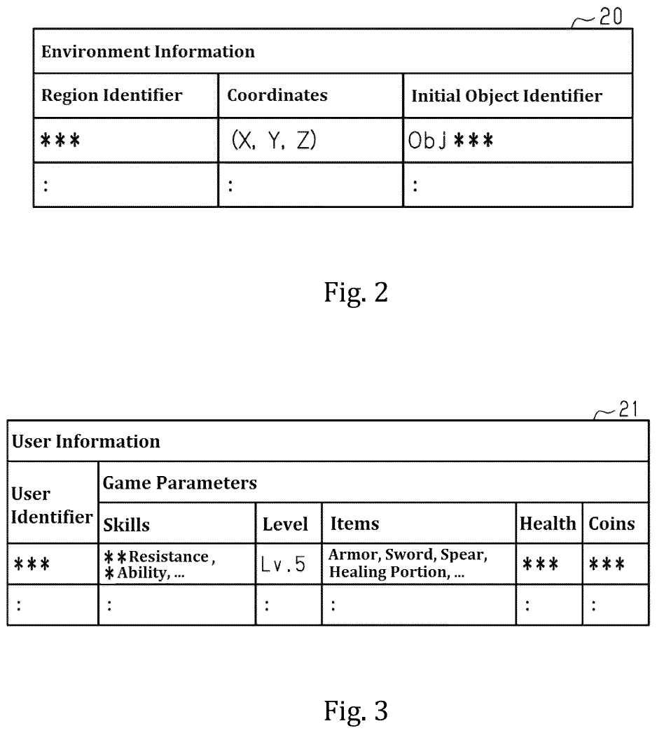

FIG. 2 illustrates an example of the environment information 20. The environment information 20 is generated for each region included in the virtual space. Examples of regions that can be set in the virtual space include game fields such as “forest,” “wilderness,” “ocean,” “desert,” and “ice field.” These game fields may also be referred to as climate zones. The environment information 20 includes an identifier and coordinates of a region, and an identifier of an initial object preset in the region. The coordinates indicate a range of the region. The initial object is an object that is arranged in the region before the user starts the automatically generated game. That is, the initial object is arranged in the virtual space at the start of the game. For example, in the “forest” region, “trees” are arranged as the initial object. Each item of data of the environment information 20 may be structured into one row or entry of one table as in the example of FIG. 2, or may be structured into a plurality of rows or entries of one or more tables. The environment information 20 need not be representable by a table, and may include at least one piece of unstructured data. The same applies to the user information 21, the reward information 33, and the object candidate information 34 shown in FIGS. 3 to 5.

The regions are now described. The regions have different characteristics from one another and are selectable by the user. Each region may differ from the other regions in the types of initial objects, the number of initial objects, or both, and may also differ in weather, climate, or both. The environment information 20 set for each region is used when automatically generating the game content. Therefore, the environment information 20 affects the difficulty level of the game content. The “difficulty level” herein refers to a degree of difficulty for the user to complete a mission, and the higher the difficulty level, the more difficult it becomes to complete the mission.

The coordinate data included in the environment information 20 is now described. The coordinate data includes terrain data representing the terrain of the corresponding region. For example, the terrain data includes mesh data having coordinates in the virtual space and texture data. The mesh data is a collection of points (vertices), lines (edges), and surfaces (polygons). The vertices included in the mesh data have three-dimensional coordinates. The Y-coordinate of a vertex indicates a height. Undulations of the terrain are represented by connecting a plurality of the vertices with the edges. The texture data is superimposed on the mesh data and is, for example, an image or a pattern arranged on a surface of an object.

The terrain affects the difficulty level of the game content. For example, health (HP) is set for a character object operated by the user. Furthermore, for the character object, the amounts of health loss are set for actions such as jumping and climbing a wall. As the character object performs an action, the processor 15 subtracts the amount of health lost by the action from the health of the character before the action. For example, when the character object moves across a terrain with large undulations, the character object frequently performs actions such as jumping, resulting in increased health loss. In addition, when a region such as a “desert” is a target of physical-behavior simulation, the moving speed of the character object across that region can be reduced, as described below. In other words, the amount of health lost per distance traveled by the character object can be increased.

The initial objects are now described. The initial objects include stationary objects arranged at fixed positions and moving objects that are movable within a region. For example, the stationary objects include structures such as plants and buildings, and other game-specific objects. The moving objects include animals inhabiting the region, enemy characters that battle with the character object, vehicles, and other game-specific objects.

At least some of these objects are configured with components (programs) for performing a simulation of physical calculations using a predetermined law of mechanics or the like in response to predetermined triggers. The processor 15 performs physical behavior simulation calculations for the objects with the components when the triggers such as contact with other objects occur. For such objects, settings regarding, for example, mass, air resistance, collision with other objects, and friction with other objects are specified. As one example of a simulation performed by the component, when a collider defining a boundary for collision detection is configured for an object, the object can be prevented from passing through another object upon contact. As another example, the friction setting can decelerate a moving object while it is in contact with another object. Furthermore, in addition to or instead of the component for simulating physical behavior, these objects may be configured with a component for simulating a chemical state change according to a predetermined rule, as described later. Configuration information for performing these simulations may be included in the environment information 20.

For example, as the number of collidable objects in a region increases, it becomes more difficult for the user to move the character object within the region while avoiding collisions with other objects. In addition, it becomes difficult for the user to cause the character object to continue an action such as carrying an object for which a large mass is set. The regions themselves can also be objects for which physical behavior is simulated. For example, when a friction-reducing setting is configured for a region such as an ice field, the user has difficulty causing the character object to continue an action such as moving on the ice field.

FIG. 3 illustrates an example of user information 21. The user information 21 is information associated with each user and includes a user identifier, game parameters, and the like. In the example of FIG. 3, the game parameters include a skill(s), level, item(s), health (hit points, stamina) of the user's character and the number of coins the user character has.

The game parameters may include other parameters instead of or in addition to the parameters described above. For example, the game parameters include attack power, defense power, combat power, magic power (magic points), experience points, the number of skill points consumed when a skill is used, agility, the number of medals, the number of points, and the like. Further, the game parameters may also be referred to as the number or amount of game media associated with the user. The game media may be any electronic data used in the game. The electronic data can be acquired, possessed, used, managed, exchanged, synthesized, strengthened, sold, discarded, or gifted in the game by the user. For example, an item usable by a character is one of the game media. The game media further include any media such as cards, virtual currency (medals), tickets, characters, avatars, and the like. Use of the game media is not limited to the examples explicitly described herein.

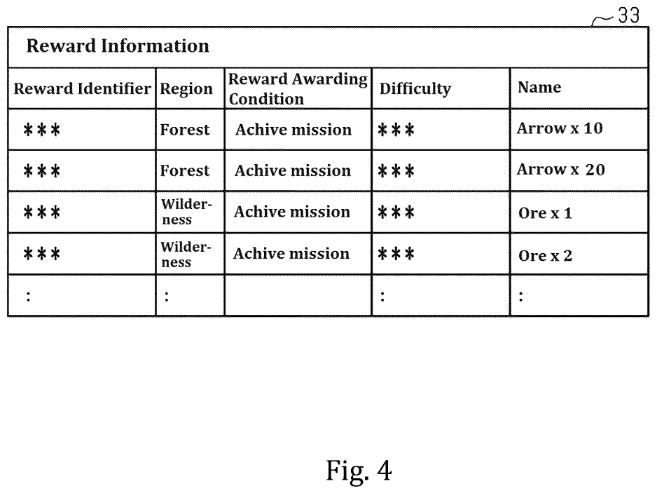

FIG. 4 illustrates an example of reward information 33. The reward information 33 indicates reward candidates that can be awarded to the user when a mission is achieved. Each reward candidate includes a reward identifier, a region, a reward awarding condition, a difficulty level, and the name (type) of the reward. The region indicates a region where a mission is achieved. The reward awarding condition is a condition under which the reward is awarded. The difficulty level indicates a level of difficulty (degree of difficulty) for achieving the mission. When the user achieves a mission in a predetermined region, the processor 15 selects, as a reward to be given to the user, the reward candidate corresponding to the difficulty level of the mission achieved from among the reward candidates associated with the region. Here, one type of reward is associated with each region (e.g., arrows for the forest), and the quantity thereof is set according to the difficulty level (e.g., 10 or 20 arrows).

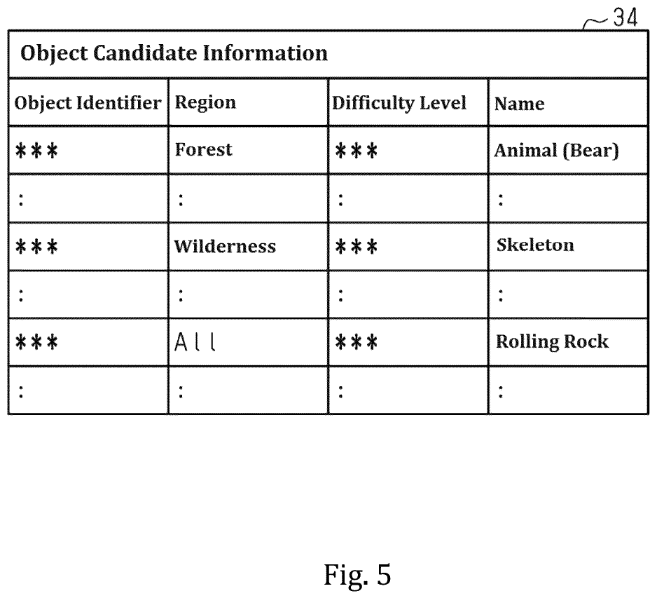

FIG. 5 illustrates an example of object candidate information 34. The object candidate information 34 indicates object candidates that can be arranged in a region when automatically generating the game content. The object candidate information 34 includes, for each object candidate, an object identifier, a region, a difficulty level, and a name of the object. The processor 15 selects at least one object from among the object candidates according to the region and sets the selected object in the region as an additional object. Furthermore, the object candidate information 34 may include information regarding objects applied to all the regions (“All” in FIG. 5) selectable in a single “stage” (to be described later).

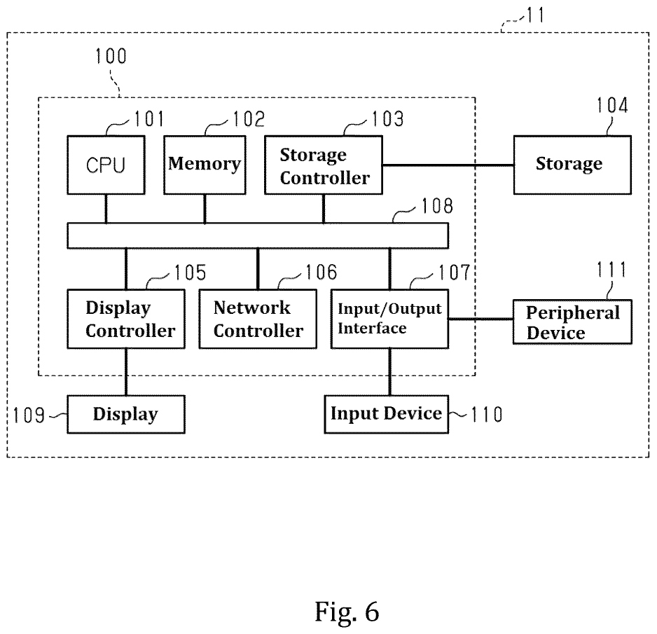

A hardware configuration of the user device 11 will be described with reference to FIG. 6. A hardware configuration of the management server 12 is similar to that of the user device 11. The user device 11 includes processing circuitry 100, a storage 104, a display 109, an input device 110, and a peripheral device 111.

The processing circuitry 100 includes at least one CPU 101, which is a processor that executes one or more of control processes disclosed herein, and a memory 102. Processed data and instructions may be stored in the memory 102. Further, the processed data and instructions may be stored in the storage 104, which is a storage medium disk such as a hard disk drive (HDD) or a portable storage medium, or may be stored in a storage medium provided separately from the processing circuitry 100. The storage 104 is connected to the CPU 101 via a storage controller 103 and a bus 108. In this exemplary embodiment, the storage 104 corresponds to the storage device 16.

The processing circuitry 100 also includes a network controller 106 for connecting to a network 13. The processing circuitry 100 further includes a display controller 105 and an input/output interface 107. The display controller 105, the network controller 106, and the input/output interface 107 are connected to the bus 108. The display controller 105 is connected to the display 109. The input/output interface 107 is connected to the input device 110 and the peripheral device 111.

The input device 110 includes a touch panel, a keyboard, a mouse, a controller operated by a hand of the user (e.g., a game controller such as a gamepad or a joystick), an operation button provided on a housing of the user device 11, and the like.

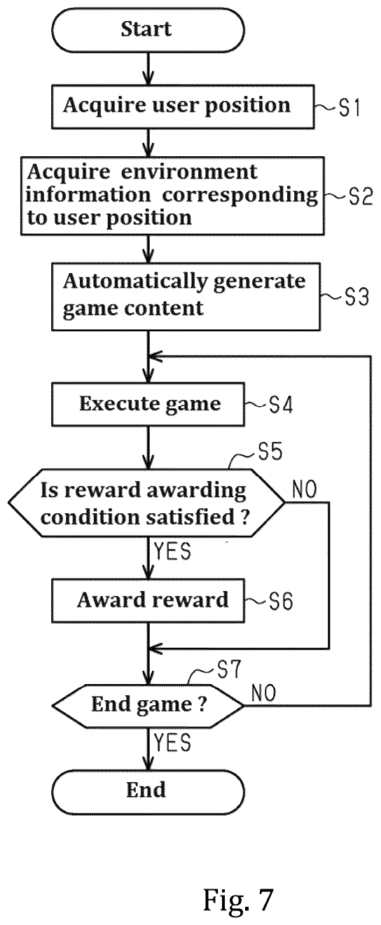

The peripheral device 111 includes a microphone for collecting sounds in the real world, such as a user's voice, and a speaker for outputting sound effects, other users'voices, and the like. The management server 12 includes the processing circuitry 100 and the storage 104 similar to those of the user device 11. In the management server 12, the input device 110, the peripheral device 111, the display 109, and the like may be omitted.

[Game Processing] A process in which the user device 11 executes computer-readable instructions will be described with reference to FIGS. 7 to 9. The order of steps described hereunder may be changed as long as there are no technical conflicts.

In this exemplary embodiment, a game in which the user progresses through stages in a predetermined order or in any order will be described. A main game includes a plurality of stages. A mission (task) is set for each stage. When the mission is achieved, the processor 15 determines that the stage has been achieved (cleared). In a game in which the stages are progressed in the predetermined order, the processor 15 enables the next stage to be executed once the current stage has been cleared. In progressing through one stage, the user can select one region from among the plurality of selectable regions. In the exemplary embodiment, the mission is common regardless of which region is selected. The processor 15 can generate multiple pieces of game content, each having a common task, by applying the environment information 20 of the selected region to the game content. Furthermore, the user can select any position in the region as a game start position.

FIG. 7 illustrates a procedure for game progress. The processor 15 acquires a user position in the virtual space (step S1). When the user operates a character object corresponding to the user, the user position is the position of the character object. In a game without character objects, the user position is a position designated by the user. The user position is represented by, for example, three-dimensional coordinates.

The processor 15 acquires the environment information 20 corresponding to the user position (step S2). Specifically, the processor 15 identifies a region including the user position and acquires the environment information 20 associated with the region from the storage device 16.

The processor 15 automatically generates game content according to an automatic generation algorithm using the acquired environment information 20 (step S3). At this time, the processor 15 sets a reward that can be awarded to the user. The processor 15 may change the reward according to the environment information 20 or the user information 21. The user starts the game content by operating the input device 110, that is, starts playing a game corresponding to the game content.

The processor 15 executes the game using the automatically generated game content (step S4). Furthermore, the processor 15 determines whether a reward awarding condition is satisfied (step S5). In this exemplary embodiment, the processor 15 determines that the reward awarding condition is satisfied when a mission associated with a stage is achieved.

When the processor 15 determines that the reward awarding condition is satisfied (YES in step S5), the processor 15 awards the reward to the user by associating the reward with the user (step S6). When the processor 15 determines that the reward awarding condition is not satisfied (NO in step S5), the process proceeds to step S7.

The processor 15 determines whether to end the game (step S7). When the processor 15 determines that the mission is achieved or that the mission has failed (YES in step S7), the processor 15 ends the game. When the processor 15 determines not to end the game (NO in step S7), the process returns to step S4.

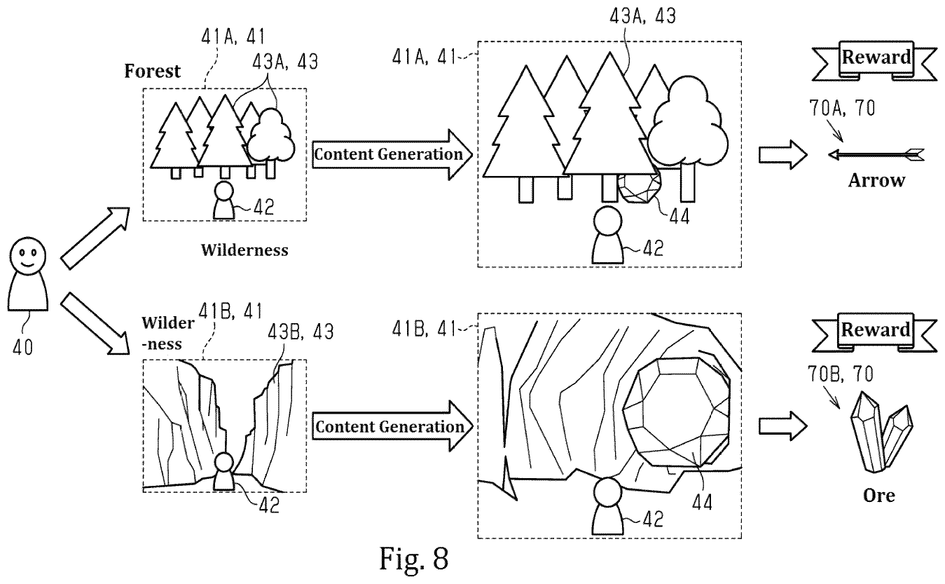

Details of each step will be described with reference to FIG. 8, along with specific examples of the game content in which the environment information 20 is reflected.

### Acquisition of User Position

The acquisition of the user position (step S1) will be described. In one stage, a user 40 operates the input device 110 to select one region 41 from among the plurality of regions 41. In the example of FIG. 8, a comparison is made between a case where the user 40 selects a “forest” region 41A and a case where the user 40 selects a “wilderness” region 41B.

After selecting the region 41, the user 40 moves a character object 42 in the virtual space and places the character object 42 at an arbitrary position. The processor 15 acquires the position of the character object 42 designated by the user 40 as the user position. The user position can be identified as a single set of coordinates within the region 41.

### Acquisition of Environment Information

The acquisition of the environment information 20 (step S2) will be described. When the user position is included in the “forest” region 41A, the processor 15 acquires the environment information 20 associated with “forest.” In the “forest” region 41A, a large number of initial objects 43A, such as “trees,” are arranged. The density of the initial objects 43A in the region 41A is higher than that in the “wilderness” region 41B. Furthermore, the region 41A is configured to have smaller undulations (unevenness) compared to the region 41B.

When, by contrast, the user position is included in the “wilderness” region 41B, the processor 15 acquires the environment information 20 associated with “wilderness.” In the “wilderness” region 41B, initial objects 43B such as rocks are arranged. The environment information 20 of the region 41B includes temperature setting information, and the temperature of the “wilderness” region 41B is set higher than that of the “forest” region 41A.

### Automatic Content Generation

The automatic generation of the game content (step S3) will be described. The processor 15 generates the game content according to the automatic generation algorithm. This automatic generation algorithm includes, but is not limited to, setting a movable path for the character object 42 and setting additional objects 44.

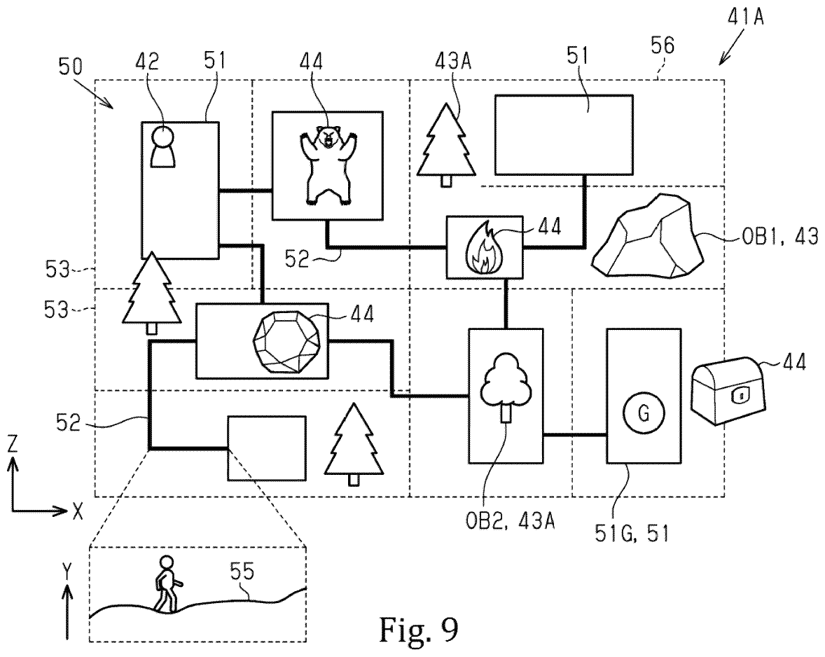

FIG. 9 illustrates a movable path 50 formed in the region 41A in two dimensions of an X-direction (a first horizontal direction) and a Z-direction (a second horizontal direction). The movable path 50 may be provided in an area defined by initial objects 43 or within a structure defined by partition objects such as newly added walls. This structure is, for example, a dungeon (a labyrinth or a maze).

The processor 15 sets a path formation region 56 based on the position of the character object 42, which is the user position. Then, the processor 15 configures the movable path 50 within the path formation region 56. Thus, even within the same region 41, the movable path 50 is set at different positions depending on the user position.

The movable path 50 is formed of spaces 51 (rooms) and passages 52. Each passage 52 connects one space 51 to another space 51. For example, the processor 15 randomly divides a predetermined area within the region 41A using a function for generating random numbers or the like to form a plurality of sections 53, and forms the space 51 in each of the formed sections 53. The size and position of the space 51 are randomly determined for each section 53. Then, the processor 15 randomly connects the respective spaces 51 via the passages 52 having a width smaller than that of the spaces 51.

Further, the processor 15 sets the position of the character object 42 (the user position) as a start position, and determines a space 51 (or a position) that is to be a goal position 51G of the movable path 50. As described above, the arrangement of the spaces 51 and the connections via the passages 52 are performed randomly; however, for the same path formation region 56, the movable path 50 may be defined with reproducibility. That is, if the user 40 again selects a previously selected user position as the start position, the user 40 can play the game with a movable path 50 similar to the one previously defined.

In forming the spaces 51 and the passages 52, the processor 15 configures the spaces 51 and the passages 52 based on the environment information 20 of the path formation region 56. For example, in FIG. 9, the processor 15 may configure the spaces 51 and the passages 52 to avoid an initial object OB1 of a “stationary rock” shown on the right side of the drawing. That is, the processor 15 may configure the spaces 51 and the passages 52 so as not to include a position overlapping the initial object 43A. Alternatively, as with an initial object OB2 of a “tree” shown in the lower part of FIG. 9, the processor 15 may configure the spaces 51 and the passages 52 such that the initial object 43A is included in the space 51 or the passage 52, that is, such that the space 51 or the passage 52 includes the position overlapping the initial object 43A.

As shown in the lower left of FIG. 9, a terrain 55 based on the environment information 20 is reflected in the movable path 50. When the terrain 55 of the path formation region 56 has undulations in a Y-direction (a height direction), the passages 52 and the like also have undulations in the Y-direction. The processor 15 forms the spaces 51 and the passages 52 three-dimensionally according to mesh data representing the terrain 55. That is, the spaces 51 and the passages 52 have three-dimensional coordinates of the terrain 55 based on the environment information 20. Further, when the path formation region 56 is formed in a region 41 that reduces friction in the “desert” or “ice field,” friction against the character object 42 is reduced. Furthermore, the processor 15 controls the weather and climate of the path formation region 56 in the region 41 according to the environment information 20. For example, when the region 41 is a “tropical rain forest,” the processor 15 causes rain to fall in the path formation region 56.

Configuration of the additional objects 44 will be described. The additional objects 44 are objects involved in a mission(s) or objects for providing a game content mechanism (gimmick). A component for simulating a physical behavior of an object based on a predetermined rule such as a law of physics, or a component for simulating a chemical state change, is associated with the additional objects 44.

The processor 15 selects, from the object candidate information 34, an additional object(s) 44 related to a mission(s) as well as an additional object(s) 44 associated with the region 41A. For example, it is assumed that the missions common to the regions 41A and 41B include “avoiding collision with a rolling rock” and “searching for and opening a treasure chest.” The processor 15 selects the additional objects 44 related to the missions and selects other additional objects 44. Then, the processor 15 randomly arranges the selected additional objects 44 based on conditions such as a condition that positions to dispose the selected additional objects 44 do not overlap with the initial objects 43A. For example, the processor 15 selects the “rolling rock” additional object 44 and the “treasure chest” additional object 44 as the mission-related additional objects 44. Furthermore, the processor 15 selects “animal (bear)” and “fire” as other additional objects 44. A component for executing a physical simulation is associated with the “animal (bear)” additional object 44, and a component for executing a chemical simulation is associated with the “fire” additional object 44.

The processor 15 may change the number of additional objects 44 other than the additional objects 44 related to the missions depending on the selected region 41 or the user position. The number of additional objects 44 may be determined depending on the type of the region 41, the number of spaces 51 or passages 52, the size of the spaces 51, the travel distance from the start position to the goal position 51G, the maximum height difference of the movable path 50 in the Y-direction, the number of the initial objects 43A, and the like.

Further, the processor 15 configures a reward according to the environment information 20. At this time, the processor 15 selects a reward corresponding to the region 41 from the reward information 33. Furthermore, the processor 15 may estimate the difficulty level of the generated game content and transmit a reward request including an identifier of the region 41 and the difficulty level to the management server 12. The difficulty level may be associated with the region 41. For example, a difficulty level of “1” may be associated with the “forest” region 41A, and a difficulty level of “2” may be associated with the “wilderness” region 41B. Alternatively, this difficulty level may reflect the difficulty of defeating an opponent, which is the additional object 44. Alternatively, the difficulty level may be determined depending on the number of spaces 51 or passages 52, the size of the spaces 51, the travel distance from the start position to the goal position 51G, the maximum height difference of the movable path 50 in the Y-direction, the number of the additional objects 44, the number of the initial objects 43A, the size, mass, or level of the additional objects 44, and the like. The management server 12 determines the reward based on the identifier of the region 41 and the difficulty level, and transmits an identifier of the determined reward to the user device 11. Here, the management server 12 determines the type of the reward depending on the region 41 and determines the quantity of the reward according to the difficulty level.

### Game Execution

The execution of the game (step S4) will be described. After generating the game content, the processor 15 executes the game based on instructions from the user 40.

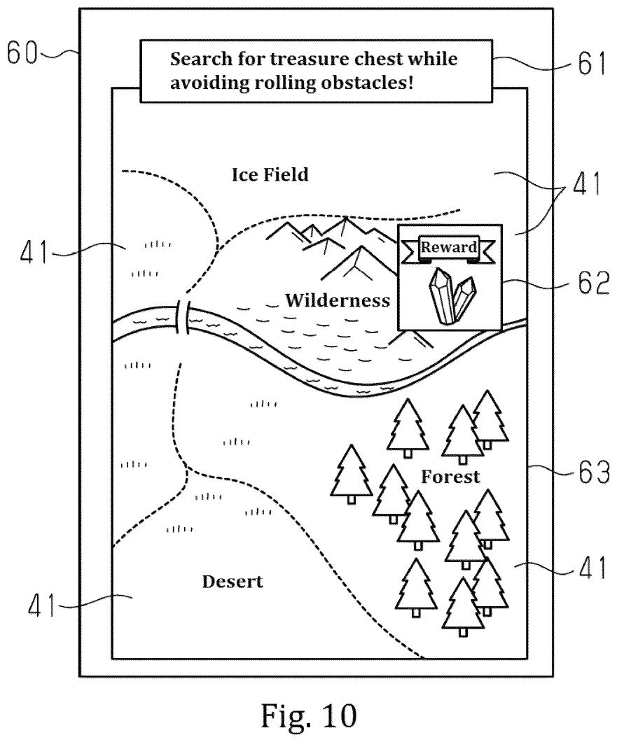

FIG. 10 shows an example of a start screen 60 displayed on the display 109 before the processor 15 starts the game content. The start screen 60 includes a mission detail display 61, a reward display 62 regarding rewards to be granted when a mission is achieved, and a region display 63 regarding the region 41 such as a map. In the example of FIG. 10, the reward display 62 is shown by the user 40 performing an operation to temporarily select the region 41.

The user 40 understands, via a tutorial, a notification from an official game account, or the like, that the region 41 is selectable within one stage and that the difficulty level and the rewards of the game content change depending on the selected region. Therefore, the user 40 selects the region 41 and the start position (user position) in consideration of compatibility between the mission set for the stage and the region 41, the user's own proficiency in the game, desired rewards, and the like. Note that on the start screen 60 of FIG. 10, the difficulty level of each region 41 may be displayed. For example, the start screen 60 may display relative difficulty levels compared among the regions 41.

The compatibility between the mission and the region 41 is now described. A mission-related additional object 44 may produce different operations or effects depending on the region 41 in which it is placed and on its position within the region 41.

In the example of FIG. 8, when an interval between the “tree” initial objects 43A disposed in the region 41A is smaller than the size (diameter) of the “rolling rock” additional object 44, the additional object 44 collides with the “tree” initial objects 43A and stops. As a result, the user 40 does not need to avoid the additional object 44, and thus the difficulty level of the game is relatively low.

When, by contrast, the game is executed in a dungeon constructed in the “wilderness” region 41B, there is little space for the character object 42 to avoid the “rolling rock” additional object 44. Therefore, the difficulty level of avoiding the additional object 44 is higher than in the “forest” region 41A. In a region such as the “desert,” by contrast, the additional object 44 does not roll readily on the terrain 55, so the difficulty level of avoiding the additional object 44 is relatively low in such a region.

An object for which chemical simulation is enabled may likewise produce different operations or effects depending on the region 41 in which it is placed and on its position within the region 41. For example, when many chemically simulated “tree” initial objects 43A are located near the “fire” additional object 44, the “fire” additional object 44 burns the “tree” initial objects 43A and expands the combustion range. When the “fire” additional object 44 is instead placed in a region 41 such as the “ice field,” it melts surrounding initial objects 43 such as “icebergs,” and the processor 15 determines the range over which the initial objects 43 melt based on the size of the “fire” and the size of the “iceberg.” The user 40 may know in advance which additional object 44 will be placed—for example, because the user 40 has played the same stage before, or because mission details are presented before the game starts. Knowing that the “fire” additional object 44 will be placed, the user 40 may select a region 41 such as the “ice field” or “ocean” for compatibility with the “fire,” or may instead select a region 41 such as the “forest” or “grassland” to expand the state change caused by the additional object 44 and thereby burn other obstacles.

In this manner, the user 40 can estimate the details of the mission or the compatibility between the region 41 and the additional object 44 placed according to the mission, and can select the region in consideration of the user's own proficiency in the game. For example, when the user's proficiency in the game is low, the user 40 can select the region 41 considered to have a lower difficulty level. Further, the density of the initial objects 43 in the region 41 is not uniform, and the undulation varies depending on the position in the region 41. Therefore, after selecting the region 41, the user 40 can select a position where it is presumed that the mission will be easily achieved, and explore the selected position. Alternatively, the user 40 can explore a position where the difficulty level is higher in expectation of an increase in the quantity of the rewards. Because the details of the game content change depending on the position selected by the user 40, the user can formulate a strategy for achieving the mission. In addition, the details of the game content can differ between plays of the same stage.

### Awarding of Reward

The determination of whether or not the reward awarding condition is satisfied (step S5) and the awarding of a reward (step S6) will be described. The reward awarding condition may include, in addition to the mission being achieved, a condition regarding an event in the game. The condition regarding the event includes, for example, having defeated an opponent, having reached the goal point, and the like. Upon determining that the reward awarding condition is satisfied, the processor 15 selects the reward based on the reward information 33.

Operation of the first exemplary embodiment is described below. (1-1) The processor 15 automatically generates the game content using the environment information 20 corresponding to the user position. Because the details of the game content vary depending on the position selected by the user 40, the user 40 can vary the game content by selecting different positions, and the information processing system 10 can generate differing game content without separately developing each piece of game content in advance.

(1-2) The processor 15 reflects, in the game content, the terrain of the region 41 that includes the position selected by the user 40. The user 40 can therefore select the region 41 with reference to the terrain.

(1-3) The processor 15 sets the movable path 50, through which the user 40 can move in the virtual space, in accordance with the positions of the initial objects 43. The user 40 can therefore select a region 41 with reference to the arrangement of the initial objects 43.

### Second Exemplary Embodiment

A second exemplary embodiment of the information processing system, the information processing method, and the program will be described below.

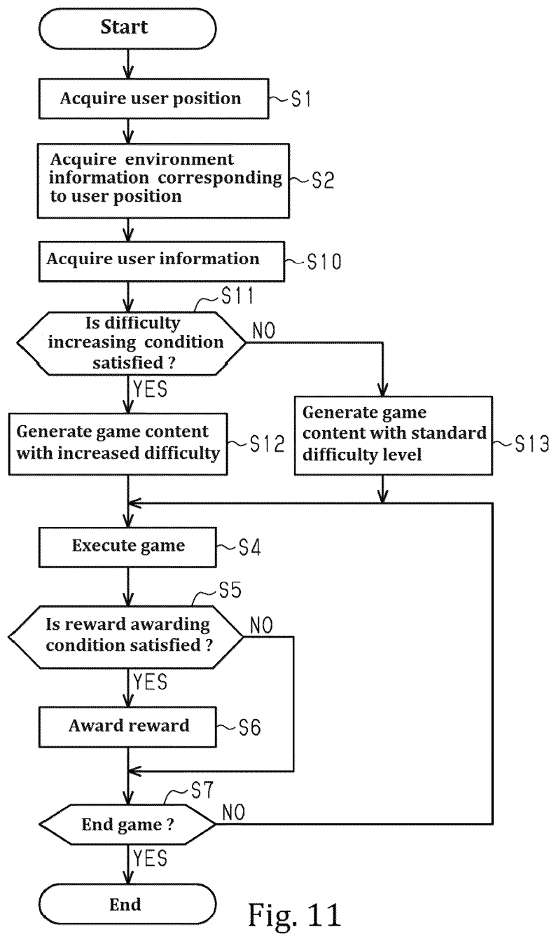

Hereinafter, elements similar to those in the first exemplary embodiment are denoted by the same reference numerals, and a detailed description thereof will be omitted. Processing performed by the processor 15 by executing computer-readable instructions will be described with reference to FIG. 11. The order of steps described hereunder may be changed as long as there are no technical conflicts.

As in the first exemplary embodiment, the processor 15 acquires the user position (step S1). Further, the processor 15 acquires the environment information of the user position (step S2). Next, the processor 15 acquires the user information 21 (step S10). Then, the processor 15 determines whether the user information 21 satisfies a condition for increasing the difficulty level of the game (step S11). Specifically, the processor 15 may determine whether one of the values among the game parameters included in the user information 21 satisfies the condition for the difficulty level increase. The game parameters are variables that reflect results of plays by the user 40, such as the level, attack power, defense power, magic power, and the like of the user 40. The increase condition is, for example, that a predetermined variable is equal to or greater than a reference value. For a game parameter for which a low value is advantageous in the game, the increase condition is, for example, that the value is equal to or less than the reference value.

Alternatively, the processor 15 may determine whether item information included in the user information 21 satisfies the condition for the difficulty level increase. Items reflect the results of game plays by the user 40, influence the game, and are possessed by the user 40. For example, the items are displayed as three-dimensional objects or two-dimensional images within the game. The items include equipment such as a weapon or armor, a vehicle, food and drink, currency, a precious stone, and the like. In this case, the condition for the difficulty level increase is a condition that the user 40 possesses a predetermined item or that the user 40 possesses a predetermined number or more of the predetermined items.

When the processor 15 determines that the user information 21 satisfies the condition for the difficulty level increase (step S11: YES), the processor 15 generates game content with an increased difficulty, namely high-difficulty game content (step S12). The difficulty level is increased according to the increase condition. For example, when the condition for the difficulty level increase is a condition that a value of “attack power,” which is a predetermined parameter, is greater than or equal to a reference value, the processor 15 sets the difficulty level to a degree such that a mission can be achieved by having an attack power greater than or equal to the reference value. For example, when the condition for the difficulty level increase is a condition such as possessing a predetermined item, the processor 15 arranges the additional object 44 that requires the item to achieve the mission.

Upon determining that the user information 21 does not satisfy the increase condition (step S11: NO), the processor 15 generates game content with a standard difficulty level (step S13). Further, in steps S12 and S13, the processor 15 configures a reward according to the difficulty level. Specifically, the processor 15 sets higher-value rewards for higher difficulty levels. For example, when the processor 15 increases a game parameter as a reward, the amount of increase for high-difficulty game content is larger than the amount of increase for standard-difficulty game content. Likewise, when the processor 15 awards “currency” or an “item” to the user 40 as the reward, the quantity of the reward for the high-difficulty game content is greater than the quantity of the reward for the standard-difficulty game content.

Upon determining that the reward awarding condition is satisfied (step S5: YES), the processor 15 awards the reward to the user by associating the reward configured in step S12 or S13 with the user (step S6).

The second exemplary embodiment provides the following operation in addition to that described in (1-1) to (1-3) above.

(2-1) The processor 15 automatically generates game content in accordance with the user information 21, so that both the environment information 20 and the user information 21 are reflected in the game content. Accordingly, even when the user 40 starts the game at the same position at a different time, the details of the game content can differ from previous play sessions when a parameter such as the level of the user 40 has increased relative to past play.

The above exemplary embodiments may be modified as described below. The above exemplary embodiments and the following modifications may be combined with one another to the extent that such combinations are not technically inconsistent. [Game] In each of the above exemplary embodiments, the information processing system 10 and the like have been described as providing a game in which the stages included in the main game are advanced in a preset order or arbitrary order; however, the main game does not necessarily have to include stages. In other words, a game consisting of a single stage may be provided. The type of the game may be a role-playing game, a shooting game, an action game, a racing game, a fighting game, a training simulation game, a romance simulation game, a puzzle game, a card game, a sports game, a rhythm game, or the like.

In each of the above exemplary embodiments, the user 40 can select an arbitrary position within the region 41 as the game start position; however, the game start position may instead be predetermined for each region 41.

In each of the above exemplary embodiments, the processor 15 may set different missions for the “forest” region 41 and the “wilderness” region 41. Further, the user 40 may be allowed to select a mission before the game content is automatically generated.

The environment information 20 may include the environment information of a real-world position of the user 40 who plays the game. The user device 11 has a position detection function for detecting the real-world position by communicating with a Global Navigation Satellite System. The user device 11 acquires the environment information 20 corresponding to the real-world position from the management server 12 or the like. According to this aspect, when the user 40 is in an urban area, the user device 11 sets the movable path 50 using the environment information 20 of the urban area and reflects the weather or the like of the urban area in the movable path 50. Further, the environment information 20 may reflect a time slot in which the game is played. For example, when the user 40 plays the game during a nighttime period (for example, “20:00”), the processor 15 may set the region 41 to a nighttime state and darken the movable path 50.

In each of the exemplary embodiments described above, the processor 15 configures the movable path 50 using the environment information 20. Alternatively, the processor 15 may add the additional object 44 without setting the movable path 50 in the path formation region 56. In this case, the character object 42 can move to an arbitrary position based on instructions from the user 40.

In each of the exemplary embodiments described above, the processor 15 sets the additional object 44 in the movable path 50. Alternatively, the additional object 44 may be omitted as long as the movable path 50 can be formed.

[Rewards] In each of the above exemplary embodiments, the type of reward is determined according to the region 41. Alternatively or additionally, the type of reward may be changed depending on the game start position in one region 41. Alternatively, even when the game is played in the same region 41, the type of reward may be changed depending on the date and time when the game is played.

In each of the above exemplary embodiments, the start screen 60 includes the reward display 62 regarding the rewards; however, the reward display 62 may be omitted when the rewards have not been determined at the time of starting the game. In each of the above exemplary embodiments, the user device 11 automatically generates the game content and progresses the game. Alternatively, the management server 12 may execute at least some of the plurality of processes executed by the user device 11 in the above exemplary embodiments, such as the automatic generation of content and the progress of the game.

The user device 11 may display the game screen using an independent web browser stored in the storage 104. The user device 11 receives, from the management server 12, web data described in a markup language such as HTML (HyperText Markup Language) and using CSS (Cascading Style Sheets), JavaScript (registered trademark), or the like. A web browser program started on the user device 11 renders the virtual space by means of JavaScript operating on the browser. Alternatively, an application including an in-app browser may be installed on the user device 11.

In a browser rendering system, at least one of known methods may be used as an approach for generating a file for displaying a virtual space screen by rendering, such as Static Server-Side Rendering (Static SSR), Server-Side Rendering (SSR), Client-Side Rendering (CSR), CSR with Prerendering, and SSR with (Re)Hydration. Rendering here refers to interpreting data described in a markup language or the like and calculating the arrangement of image elements and characters to be displayed on the virtual space screen.

### Information Processing System

In the above exemplary embodiments, the information processing system has been described by taking a system that provides the game played by the single user 40 as an example. Alternatively, the information processing system may provide a multi-user game in which the multiple users 40 participate online, such as a Multiplayer Online Role-Playing Game (MORPG). In this case, a leader of a group (e.g., a guild master) may determine the region 41 or the game start position.

The management server 12 may be a single server device equipped with a plurality of virtual servers, or may be a set of a plurality of physical servers. [Hardware Configuration]

Each function disclosed in this specification is not limited to the CPU 101 and may be implemented using a general-purpose processor, a special-purpose processor, an integrated circuit, ASICs (Application Specific Integrated Circuits), other conventional circuits, and/or circuitry that may include a combination thereof, configured or programmed to execute the disclosed functions. The processor executes computer-readable instructions. The processor is a processing circuit or circuitry because it includes transistors and other circuits. The processor may be a programmed processor that executes a program stored in a memory. In the present disclosure, a unit or means, such as a processing circuit, is hardware that executes or is programmed to execute the above-described functions. The hardware may be any hardware disclosed herein or otherwise known that is programmed or configured to execute the mentioned functions. These processors function as the environment information acquisition unit 22, the automatic content generation unit 23, and the game progress unit 24 described above by executing computer-readable instructions.

Furthermore, the processor is not limited by the form of the computer-readable medium in which the instructions of the process are stored. For example, the instructions may be stored in a CD, a DVD, a FLASH memory of an information processing device with which the processing circuitry 100 communicates, a RAM, a ROM, a PROM, an EPROM, an EEPROM, a hard disk, or other non-transitory computer-readable media, such as a server or a computer. Further, the process may be stored in network-based storage, cloud-based storage, or other mobile-accessible storage, and may be executable by the processing circuitry 100.

Further, descriptions or blocks in the flowcharts disclosed herein can be understood as representing modules, segments, or portions of code including one or more executable instructions for implementing specific logical functions or steps in a process. Further, the descriptions or blocks of the flowcharts disclosed herein may execute two or more functions or steps in an order different from the order illustrated or described in the specification, such as substantially simultaneously or in reverse order.

Hardware elements for implementing the processing circuitry 100 may be implemented by various circuit elements. Furthermore, each function disclosed herein may be implemented by circuitry including one or more processing circuitries.

The network 13 to which the network controller 106 connects may be a public network such as the Internet, a private network such as a local area network (LAN) or a wide area network (WAN), or any combination thereof, and may also include a public switched telephone network (PSTN), an Integrated Services Digital Network (ISDN), or a subnetwork. The network 13 may also be a wired network such as an Ethernet (registered trademark) network or a Universal Serial Bus (USB) cable, or may be a wireless network such as a cellular network including 3G, 4G, and 5G wireless cellular systems. Further, the wireless network may be Wi-Fi (registered trademark), a wireless LAN, Bluetooth (registered trademark), or other known forms of wireless communication. Furthermore, the network controller 106 can comply with other direct communication standards such as Bluetooth (registered trademark), Near Field Communication (NFC), infrared, and the like.

A controller operated by a user's hand may incorporate various known sensors such as an acceleration sensor and an inertial measurement unit (IMU) such as a gyro. In another example, the input device 110 may be a tracking device that specifies a hand movement, an eye movement, or a head movement of the user 40. In this aspect, for example, an instruction from the user 40 is interpreted based on the hand movement of the user 40, and various operations such as starting or ending streaming of a video, evaluation of a message or a video, and display of a predetermined object can be executed.

What is claimed is:

1. An information processing system comprising:
processing circuitry configured to:
acquire, from a storage device that stores environment information regarding environments of a virtual space in which a user plays a game, the environment information corresponding to a position selected by the user in the virtual space;
automatically generate, using the environment information, game content for the game;
advance the game based on operations by the user; and
award a reward, corresponding to the environment information, to the user when a play result of the game by the user satisfies a reward awarding condition.

2. The information processing system according to claim 1, wherein
the environment information includes information regarding a terrain in the virtual space, and
the processing circuitry is further configured to reflect the terrain in the game content with respect to the position selected by the user.

3. The information processing system according to claim 1, wherein
the environment information includes information regarding an initial object arranged in the virtual space, and
the processing circuitry is further configured to set a movable path in the virtual space through which the user moves with respect to a position of the initial object.

4. The information processing system according to claim 3, wherein the processing circuitry is further configured to, when automatically generating the game content, set the movable path such that the movable path does not overlap with the initial object.

5. The information processing system according to claim 3, wherein the processing circuitry is further configured to, when automatically generating the game content, set the movable path such that the movable path overlaps with the initial object.

6. The information processing system according to claim 3, wherein the processing circuitry is further configured to add an additional object related to the game content to a position on the movable path that does not overlap the initial object.

7. The information processing system according to claim 3, wherein the processing circuitry is further configured to:
set a path formation region based on the position selected by the user; and
configure the movable path within the path formation region.

8. The information processing system according to claim 7, wherein the movable path includes a plurality of spaces and a plurality of passages, each of the plurality of passages connecting one of the plurality of spaces to another of the plurality of spaces.

9. The information processing system according to claim 1, wherein the processing circuitry is further configured to automatically generate the game content using the environment information and user information associated with the user.

10. The information processing system according to claim 1, wherein the processing circuitry is further configured to:
set a movable path in the virtual space through which the user is able to move; and
add, to the movable path, an additional object to which a simulation is applied.

11. The information processing system according to claim 10, wherein the simulation simulates a physical behavior of the additional object based on mechanical properties of the object and environment of the virtual space.

12. The information processing system according to claim 10, wherein the simulation simulates a chemical state change of the additional object according to chemical properties of the object and environment of the virtual space.

13. A method comprising:
acquiring, from a storage device that stores environment information regarding environments of a virtual space in which a user plays a game, the environment information corresponding to a position selected by the user in the virtual space;
automatically generating, using the environment information, game content for the game;
advancing the game based on operations by the user; and
awarding a reward corresponding to the environment information to the user when a play result of the game by the user satisfies a reward awarding condition.

14. The method according to claim 13, wherein
the environment information includes information regarding an initial object arranged in the virtual space, and
the method further comprises setting a movable path in the virtual space through which the user moves with respect to a position of the initial object.

15. The method according to claim 14, further comprising:
setting a path formation region based on the position selected by the user; and
configuring the movable path within the path formation region.

16. The method according to claim 14, further comprising adding, to the movable path, a new object to which a simulation is applied.

17. A non-transitory computer-readable medium storing computer executable instructions which, when executed by processing circuitry, cause the processing circuitry to perform a process comprising:
acquiring, from a storage device that stores environment information regarding environments of a virtual space in which a user plays a game, the environment information corresponding to a position selected by the user in the virtual space;
automatically generating, using the environment information, game content for the game;
advancing the game based on operations by the user; and
awarding a reward corresponding to the environment information to the user when a play result of the game by the user satisfies a reward awarding condition.

18. The non-transitory computer-readable medium according to claim 17, wherein
the environment information includes information regarding an initial object arranged in the virtual space, and
the process further comprises setting a movable path in the virtual space through which the user moves with respect to a position of the initial object.

19. The non-transitory computer-readable medium according to claim 18, wherein the process further comprises:
setting a path formation region based on the position selected by the user; and
configuring the movable path within the path formation region.

20. The non-transitory computer-readable medium according to claim 18, wherein the process further comprises adding, to the movable path, a new object to which a simulation is applied.
